(19) United States
(12) Patent Application Publication
(10) Pub. No.: US 2009/0184099 A1
(43) Pub. Date: Jul. 23, 2009

(54) Compressed Air Welding Fume Shield System and Method

(75) Inventors: Michael J. Eddington, Gladewater, TX (US); Donald R. Loyd, Gilmer, TX (US); James A. Minton, Longview, TX (US); Milton T. Satterwhite, Longview, TX (US); Donald P. Rager, JR., Longview, TX (US)

Correspondence Address: BAKER BOTTS L.L.P., 2001 ROSS AVENUE, SUITE 600, DALLAS, TX, 75201-2980, US

(73) Assignee: Trinity Industries, Inc., Dallas, TX (US)

(21) Appl. No.: 12/176,941

(22) Filed: Jul. 21, 2008

Related U.S. Application Data
(60) Provisional application No. 61/021,784, filed on Jan. 17, 2008.

(51) Int. Cl. B23K 9/16

(52) U.S. Cl. 219/137.41

(57) ABSTRACT

In accordance with a particular embodiment of the present disclosure, an apparatus for shielding welding fumes includes a device configured to engage a welding gun. The device is configured to emit a flow of air through the one or more orifices. The flow of air is operable to divert welding fumes away from a welder.

### RELATED APPLICATION

This application claims the benefit of U.S. Provisional Application Ser. No. 61/021,784 filed Jan. 17, 2008, entitled Compressed Air Welding Fume Shield System and Method, which is hereby incorporated by reference.

### TECHNICAL FIELD

The present disclosure relates generally to welding systems, and more particularly to compressed air welding fume shield systems and methods.

### BACKGROUND

Welding is often used to join various components, particularly metal components. The welding process may generate gases and particulate matter that may be hazardous if inhaled. Thus, safeguards such as proper ventilation or a welding fume extraction system may make welding safer. Unfortunately, sufficient ventilation is not always possible when welding in certain areas. Moreover, welding often occurs in confined spaces that are not suitable to accommodate conventional welding fume extraction systems.

### SUMMARY

In accordance with a particular embodiment of the present disclosure, an apparatus for shielding welding fumes includes a device configured to engage a welding gun. The device is configured to emit a flow of air through the one or more orifices. The flow of air is operable to divert welding fumes away from a welder.

Technical advantages of particular embodiments of the present disclosure include a welding fume shielding device that is easily manufactured and adapted to a variety of commercially available welding guns to protect a welder from toxic fumes. In addition, in certain embodiments, the welding fume shielding device may be attached to the welding gun in such a manner to allow the welding gun nozzle to be removed during maintenance.

Further technical advantages of particular embodiments of the present disclosure include a welding fume shielding device that is operational in confined locations that cannot accommodate a conventional welding fume extraction system.

Further technical advantages of embodiments of the present disclosure include a compressed air welding fume shield that may divert welding fumes away from a welder but will not blow shielding gas away from the weld. Shielding gas may be used to keep contaminants such as Oxygen and Nitrogen out of the weld.

Yet even further technical advantages of particular embodiments of the present disclosure include a welding fume diverter that can be operated when welding and automatically shut off when not welding.

Other technical advantages will be readily apparent to one of ordinary skill in the art from the following figures, descriptions, and claims. Moreover, while specific advantages have been enumerated above, various embodiments may include all, some, or none of the enumerated advantages.

### BRIEF DESCRIPTION OF THE DRAWINGS

A more complete understanding of embodiments of the disclosure will be apparent from the detailed description taken in conjunction with the accompanying drawings in which:

FIG. 1 illustrates a welding operation performed on a railway car in accordance with an embodiment of the present disclosure;

FIG. 2 illustrates a side view of a welding fume shielding system employing a hole-tubing shielding device in accordance with a particular embodiment of the present disclosure;

FIG. 3 illustrates a side view of a portion of a welding fume shielding system employing a slot-tubing shielding device in accordance with a particular embodiment of the present disclosure;

FIG. 4 illustrates a side view of a portion of a welding fume shielding system employing a gap shielding device in accordance with a particular embodiment of the present disclosure;

FIG. 5 illustrates a cross section of the welding fume shielding system of FIG. 4 in accordance with a particular embodiment of the present disclosure;

FIG. 6 illustrates a side view of a welding fume scoop diverter in accordance with a particular embodiment of the present disclosure;

FIG. 7 illustrates an isometric view of a portion of a welding fume manifold diverter employing perimeter holes in accordance with a particular embodiment of the present disclosure;

FIG. 8 illustrates an isometric view of a portion of a welding fume manifold diverter employing face holes in accordance with a particular embodiment of the present disclosure; and

FIG. 9 illustrates an isometric view of a helmet welding fume diverter in accordance with a particular embodiment of the present disclosure.

### DETAILED DESCRIPTION

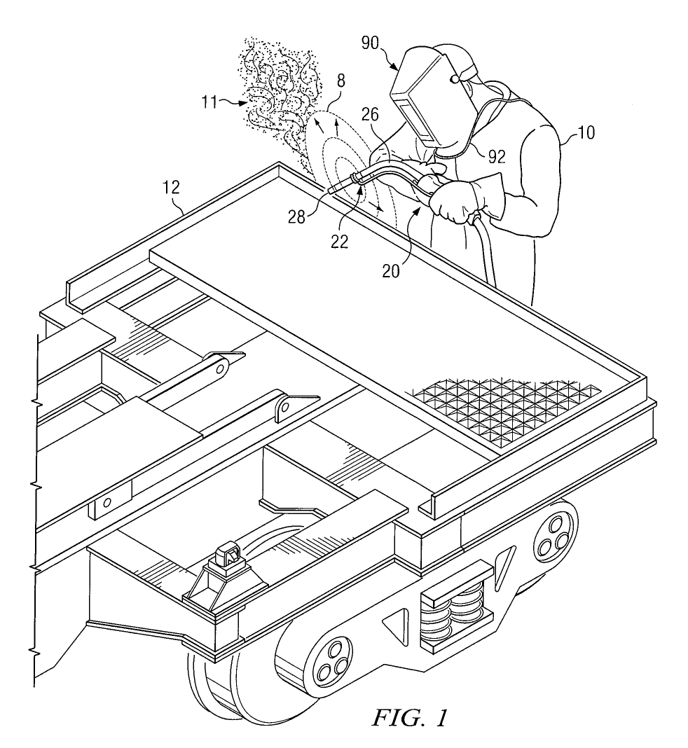

Example embodiments of the disclosure and their advantages are best understood by referring to FIGS. 1-9 of the drawings.

Welding smoke from automatic and semi-automatic arc welding may create inhalation hazards for a welder. For example, the welding of two work pieces may produce gases or particulate matter that may be hazardous if inhaled or absorbed through the skin. Exposure to, and inhalation of, this hazardous material may be minimized by employing particular embodiments of the present disclosure.

FIG. 1 illustrates a welding operation in accordance with particular embodiments of the present disclosure. The welding operation may be carried out by welder 10. Welder 10 may use welding gun 20 to join two work pieces. The work pieces may be parts of railway car 12. Although FIG. 1 illustrates welding performed on a railway car, the present disclosure is not limited to welding operations involving railway cars or other railway equipment. Rather, the teachings of the present disclosure may be employed in any welding process where two or more work pieces are joined. The welding process may be gas metal arc welding (GMAW) or flux-cored arc welding (FCAW) or any other known welding technique that produces fumes that may be hazardous if inhaled by welder 10.

A welding process in accordance with certain embodiments of the present disclosure may include the formation of a barrier or air curtain 8 that may deflect or divert welding smoke 11 from the face area of welder 10. Air curtain 8 may be formed by forcing air at an increased velocity through orifices in a diverter apparatus. Smoke 11 that is forced or prevented from reaching the face area of welder 10 may thus be less likely to be inhaled by welder 10.

An apparatus in accordance with certain embodiments of the present disclosure may allow compressed air to flow through a shroud, hood, scoop, or various arrangements of piping that are adapted to be secured to a FCAW or GMAW welding gun 20. Any suitable method to cause air to flow may be used. For example, a compressor or a fan may generate an air flow that may be delivered through slots, holes, or other orifices to divert or shield welding smoke 11 away from welder 10.

For example, welding gun 20 may include tubing 22 adapted to welding gun 20. Tubing 22 may be located on nozzle 26 of welding gun 20 and may include orifices through which air may flow. Air flowing through orifices may deflect or divert welding smoke 11 from traveling from the work pieces where it is generated to the face area of welder 10. For example, the air may form an air curtain or shield 8 that deflects or diverts welding smoke 11.

A welding fume shielding device in accordance with certain embodiments of the present disclosure may be an integral part of welding gun 20 and/or nozzle 26. It may also be adaptable to fit various commercially available welding guns or torches and may be located on nozzle 26 at a location sufficiently removed from the tip 28 of nozzle 26 such that air through tubing 22 would not interfere with the actual welding operation. Moreover, in some cases in operation, compressed air to divert or shield welder 10 from welding fumes may only be employed when the welder is actually welding the work pieces.

In accordance with another embodiment of the present disclosure, welder 10 may wear helmet 90 that includes helmet tubing 92 around the lower perimeter of welding helmet 90. Compressed air may be forced through helmet tubing 92 and exit through orifices in tubing 92. Air through these orifices may divert or shield welding smoke 11 from reaching the face of welder 10.

A welding fume shielding device or diverter in accordance with embodiments of the present disclosure may make welding safer in confined spaces where traditional fume extraction apparatuses are not an option. Also, compressed gases other than air may be used to provide a welding fume shield. For example, certain embodiments may employ any type of inert gas to create the welding fume shield.

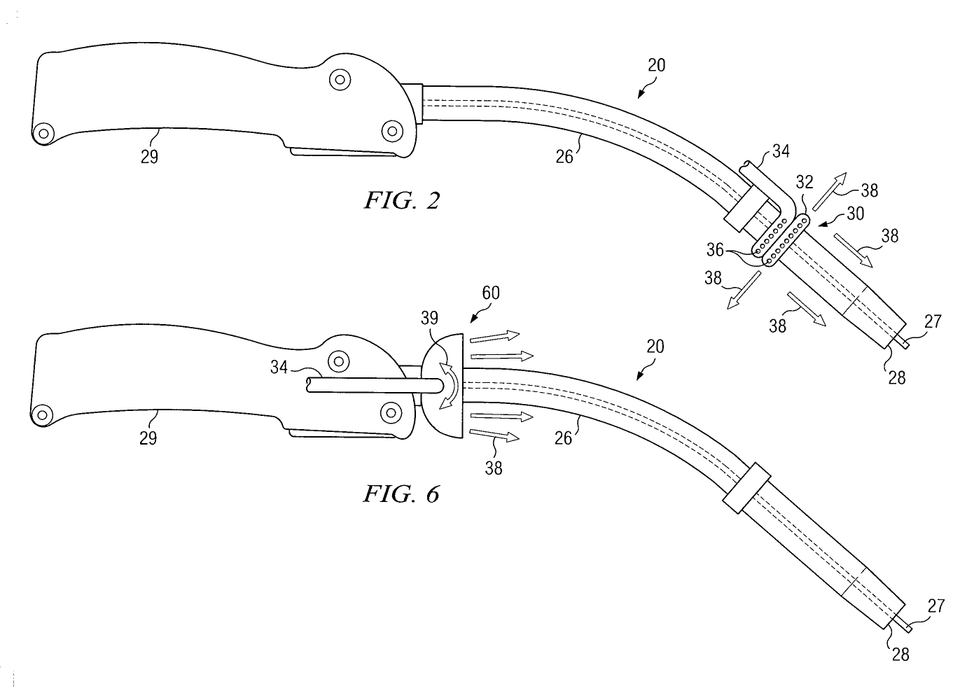

FIG. 2 illustrates welding gun 20 including hole-tubing shielding device 30. Hole-tubing shielding device 30 may provide an air curtain to restrict the upward rise of smoke from the welding arc. For example, air flowing in air flow direction 38 may provide such a barrier. Direction 38 illustrates an air flow angle. In the illustrated embodiment the air flow angle may be approximately 90 degrees or perpendicular to wire feed 27 through nozzle 26. The air flow angle of air flow direction 38 may be selected such that air forced through hole-tubing shielding device 30 creates an air curtain but does not blow shielding gas away from a weld being created with welding gun 20. In accordance with other embodiments, the air flow angle may be between zero and 90 degrees. An air flow angle of zero degrees may be parallel to wire feed 27. In other embodiments, the air flow angle may be greater than 90 degrees. The air flow angle may be any angle suitable for directing air to shield or divert welding smoke from a welder.

Welding gun 20 includes handle 29, nozzle 26, and tip 28. Welding gun 20 may be any of a variety of commercially available welding guns. Hole-tubing shielding device 30 may be fabricated from tubing or piping 32 configured to surround nozzle 26. Tubing 32 includes source tube 34. Compressed air from an external source (not shown) may be received by hole-tubing shielding device 30 through source tube 34. Hole-tubing shielding device 30 also includes holes 36. Holes 36 may surround the circumference of nozzle 26. Holes 36 may be evenly spaced apart from each other and formed in tubing 32. Holes 36 may be sized to provide sufficient air flow to create an air curtain that is capable of shielding hazardous welding smoke from a welder welding with welding gun 20.

In certain embodiments, each hole 36 may have a diameter ranging from 1/32 of an inch to ⅛ of an inch. Particular embodiments may have holes 36 with diameter ⅙ of an inch and other embodiments may have hole 36 diameters of 3/32 of an inch. However, any suitable hole 36 diameter may be used.

Holes 36 may be spaced apart from each other a distance of between 1/16 and ⅜ of an inch. Spacing between holes 36 in certain embodiments may be up to ½ of an inch. However, any suitable spacing of holes 36 may be use in accordance with embodiments of the present disclosure.

Hole-tubing shielding device 30 may be located near tip 28 of nozzle 26. Hole-tubing shielding device 30 may be located sufficiently away from tip 28 so as to not interfere with the welding operation. As stated above, the air flow direction 38 may be radially away from nozzle 26 in order to reduce interference of the air flow from with the welding operation. In particular, the air flowing from hole-tubing shielding device 30 may not blow shielding gas emitted from nozzle 26 away from the workpieces.

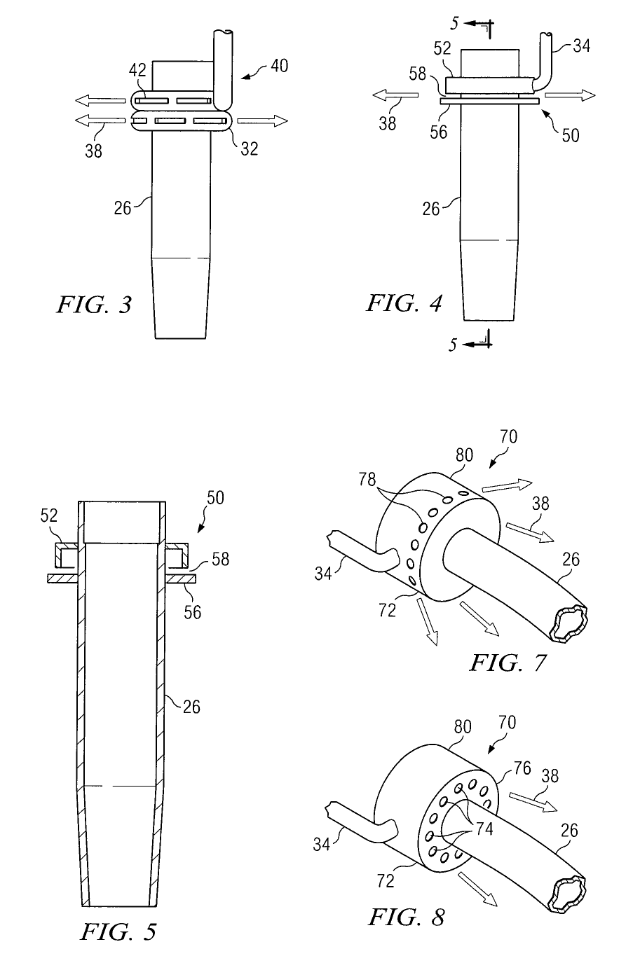

FIG. 3 illustrates another embodiment of a welding fume shielding device in accordance with the present disclosure. FIG. 3 illustrates a forward section of nozzle 26 with slot-tubing shielding device 40 surrounding nozzle 26. Slot-tubing shielding device 40 may be fabricated from metal tubing or piping and located on nozzle 26 similarly to hole-tubing shielding device 30. Slot-tubing shielding device 40 may include slots 42 in lieu of or in addition to holes 36. Multiple slots 42 may be spaced apart in tubing 32 and may circumferentially surround nozzle 26. Air flowing through slots 42 may provide an air curtain with the air flowing radially away from nozzle 26. The radial flow of air may create a curtain or barrier of air that prevents the upward rise of smoke and fumes from the welding arc occurring at the work pieces.

Yet another embodiment of a welding fume shielding device is illustrated in FIGS. 4 and 5. Similar to FIG. 3, FIGS. 4 and 5 illustrate a forward portion of nozzle 26. FIG. 5 illustrates a cross section of FIG. 4 as shown. In accordance with the illustrated embodiment of the present disclosure, air may flow through source tube 34 to gap shielding device 50. Source tube 34 may allow air from an external source to reach gap shielding device 50. Gap shielding device 50 may include annular shroud 52. Annular shroud 52 may circumferentially surround nozzle 26.

Air through source tube 34 may be directed by annular shroud 52 toward annular deflector 56. Gap 58 may be formed between annular shroud 52 and annular deflector 56. Air may be dispersed through gap 58 in air flow direction 38 to create an air curtain which may shield smoke from the welding arc from reaching the face of a welder. Gap shielding device 50 may be located on a forward portion of nozzle 26 similar to that of hole-tubing shielding device 30 and slot-tubing shielding device 40. Gap 58 may be approximately 1/16th inch. That is, there may be 1/16th inch separating annular shroud 52 from annular deflector 56 through which air may be directed to create a welding fume shielding device in accordance with a particular embodiment of the present disclosure. Gap 58 may be any suitable dimension such that when air is forced therethrough an air shield is created.

FIG. 6 illustrates a welding gun 20 in accordance with another embodiment of the present disclosure. Welding gun 20 may include handle 29 and nozzle 26. Nozzle 26 may include tip 28. In accordance with an embodiment of the present disclosure, scoop diverter 60 may provide an apparatus capable of using compressed air to divert the rise of smoke from a welding arc away from the face of a welder.

Scoop diverter 60 may be located at the base of nozzle 26 adjacent to handle 29 and may include source tube 34 through which air from an external source (not shown) may travel to reach scoop diverter 60. Scoop diverter 60 may be a hollow elliptical shape and may surround nozzle 26. Air flowing through source tube 34 may be directed by scoop 62 to disperse around nozzle 26. This air may travel in the directions indicated by air flow direction arrows 38. Air flow direction 38 may be adjusted by rotating scoop diverter 60 to a desired angle as indicated by directional arrow 39. The air flow angle of air flow direction may be rotated through 90 degrees. In certain embodiments, scoop diverter 60 may be rotated from 0 degrees, which is parallel to nozzle 26, to plus 45 degrees above nozzle 26 or it may be rotated to minus 45 degrees, which is below nozzle 26. In other embodiments, scoop diverter may be rotated greater than plus 45 degrees and less than minus 45 degrees. This rotation of scoop diverter 60 may allow a welder welding in certain positions, such as when welding overhead, to adjust airflow direction to ensure diverting air will meet hazardous smoke fumes rising from the welding arc and divert them away from the face of a welder using welding gun 20.

Air pressure of the source air flowing through the welding fume shielding devices and diverters herein described may be adjusted and varied to adequately divert the welding fumes depending on the type of welding operation. For example, a welding operation that creates a large quantity of hazardous smoke may require a higher air pressure to divert the smoke from reaching the face of the welder. In contrast, a welding operation that does not produce as much hazardous welding smoke may require less air pressure to divert the welding smoke from reaching the face area and being inhaled by a welder. In certain embodiments, an air pressure that generates an air flow velocity in the range of greater than or equal to one cubic foot per hour and less than or equal to 1000 cubic feet per hour may adequately divert welding fumes from a welder. In certain embodiments, the air flow velocity may be greater than 250 cubic feet per hour, for example 300 cubic feet per hour.

Air pressure for shielding or diverting welding smoke in accordance with an embodiment of the present disclosure may originate as a line pressure of a welding shop. This line pressure may be approximately 100 psi. A regulator may drop this line pressure to a range of between 10 psi to 30 psi. In addition, the air flow rate, volume of air, and air pressure may be controlled with a predrilled orifice in the source line. The source line may be a ¼ inch diameter hose. Welding smoke shielding air may be allowed to flow through this orifice when a solenoid is activated to the open position, and may be prevented from flowing when the solenoid is activated to the closed position. In this manner, welding smoke shielding air may be delivered when the welder desires it. For example, welding smoke shielding air may be delivered when a workpiece is actually being welded and shut off when it is not being welded.

A welding fume shield in accordance with embodiments of the present invention may not shield a welder from all of the welding smoke—a small portion may still reach the welder. However, this small portion of welding smoke may have passed through the air shield and become diluted. This diluted welding smoke may be less hazardous to the welder.

FIGS. 7 and 8 illustrate additional embodiments of a welding fume shielding device in accordance with the present disclosure. FIGS. 7 and 8 illustrate manifold diverter 70 attached to nozzle 26 of a welding gun. Manifold diverter 70 may include source pipe 34 which may be attached at its far end to an air source. Compressed air from the air source may travel through source tube 34 to manifold diverter 70. Manifold diverter 70 may also include manifold 72 having multiple holes through which compressed gas may flow. Face holes 74 may allow air to flow through manifold face 76 in the direction illustrated by air direction arrows 38. Face holes 74 may be perpendicular to face 76 into manifold 72.

An embodiment of manifold 72 may also include perimeter holes 78 as shown in FIG. 7 or holes on manifold face 76, as illustrated in FIG. 8. Perimeter holes 78 and face holes 74 may have similar diameters and spacing as described above for hole-tubing shield device 30. Perimeter holes 78 may be at an angle to manifold perimeter 80 and may allow air to leave manifold 72 at a particular direction that is selected to divert air rising from a welding arc from reaching and being inhaled by the welder. In certain embodiments, certain perimeter holes 78 and certain face holes 74 may be at different angles than other holes. Thus, a single manifold diverter 70 may allow air to travel in a range of air flow angles, which may be from zero to 90 degrees. Air flow direction 38 may be selected such that smoke rising from the welding operation may be diverted, but the diverting air does not blow the shielding gas away from the workpieces. Manifold diverter 70 may be located near the base of nozzle 26 adjacent to the handle of the welding gun similar to scoop diverter 60.

Also similar to scoop diverter 60 and the other embodiments described herein, the air pressure of air flowing to manifold diverter 70 may be adjusted to account for varying welding smoke diverting capability. Although not shown, manifold diverter 70 may include both perimeter holes 78 and face holes 74 on the same manifold.

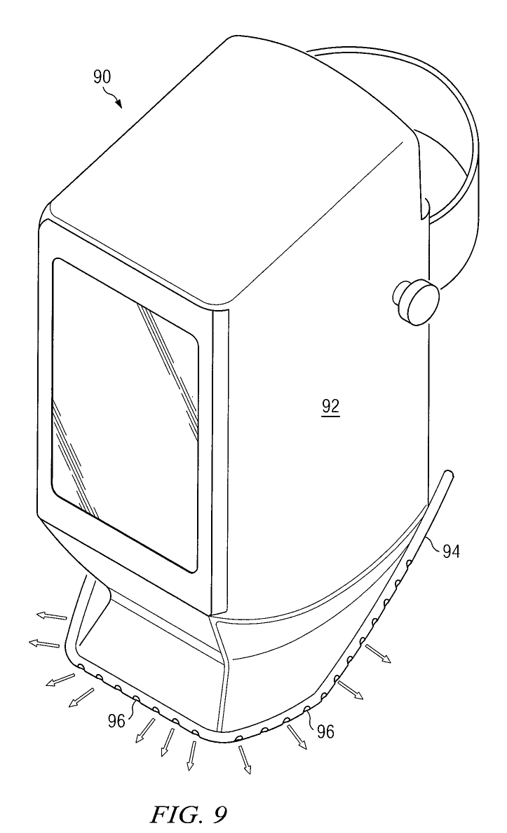

Yet another embodiment of the present disclosure is illustrated at FIG. 9. FIG. 9 illustrates helmet diverter 90. Helmet diverter 90 may include welding helmet 92. Welding helmet 92 may be any of a variety of commercially available helmets typically worn by welders to protect them from dangerous ultraviolet light from the welding arc.

Secured to welding helmet 92 may be tubing 94. Tubing 94 may be molded tubing that is configured to follow the lower perimeter of welding helmet 92 and may include multiple holes 96 that are spaced apart around the lower perimeter of welding helmet 92. A first end of tubing 94 may be closed and a second end of tubing 94 may be coupled to an external air source. The air source may provide compressed gas, for example air, through tubing 94 and out of holes 96. The air from holes 96 may be external to welding helmet 92 and may divert welding fumes from reaching the face area of a welder wearing a welding helmet in accordance with an embodiment of the present disclosure.

Although welding smoke may be allowed to rise from the welding arc to a point closer to the welder than the other embodiments herein described, helmet diverter 90 may prevent welding smoke from reaching a welder's nose and mouth area where it can be easily inhaled.

The teachings of the present disclosure and various embodiments discussed herein may be employed in any welding operation, including for example, a welding operation involving joining components of a railway car.

Although the present disclosure has been described in detail with reference to particular embodiments, it should be understood that various other changes, substitutions, and alterations may be made hereto without departing from the spirit and scope of the present disclosure. For example, any size, shape, or placement of orifices through which compressed air may be dispersed that is suitable to shield or divert welding smoke may be included in embodiments of the present disclosure. Also, any of the embodiments of the fume shielding devices or diverters discussed herein may be combined with any one or multiple other wielding fume shielding devices or diverter systems. In addition, other systems or devices that use compressed air or other gases or fluids to shield or divert welding smoke from a welder may be used in accordance with certain embodiments of the present disclosure.

Suitable gases or fluids other than air may be employed to create the welding fume shield, barrier, or diverter in accordance with certain embodiments of the present disclosure. Also, particular embodiments of the present disclosure contemplate the use of compressed air to divert welding fumes in suitable ways other than those specifically described herein.

Numerous other changes, substitutions, variations, alterations, and modifications may be ascertained by those skilled in the art and it is intended that the present disclosure encompass all such changes, substitutions, variations, alterations, and modifications as falling within the spirit and scope of the appended claims.

What is claimed is:

1. An apparatus for shielding welding fumes, comprising:
a device configured to engage a welding gun, the device having one or more orifices, the device configured to emit a flow of air through the one or more orifices, the flow of air operable to divert welding fumes away from a welder.

2. The apparatus of claim 1, wherein the device comprises a tube configured to engage a nozzle of the welding gun, the tube comprising the one or more orifices.

3. The apparatus of claim 2, wherein the one or more orifices comprises one or more holes, each having a diameter greater than or equal to 1/32 of an inch and less than or equal to ⅛ of an inch.

4. The apparatus of claim 1, wherein a direction of the flow of air is selected so the flow of air does not disturb a shielding gas emitted from a nozzle of the welding gun.

5. The apparatus of claim 1, wherein a direction of the flow of air is approximately perpendicular to a wire feed through a nozzle of the welding gun.

6. The apparatus of claim 1, wherein an air barrier is created by an increased velocity of the flow of air.

7. The apparatus of claim 1, wherein the device is configured to engage a nozzle of the welding gun at a point closer to a tip of the nozzle than a handle of the welding gun.

8. The apparatus of claim 1, wherein the one or more orifices comprise one or more slots.

9. The apparatus of claim 1, wherein the device comprises a manifold, the manifold being configured to engage a nozzle of the welding gun adjacent a base of the nozzle proximate a handle of the welding gun.

10. The apparatus of claim 9, wherein the manifold is configured to pivot through an angle to control a direction of the flow of air.

11. The apparatus of claim 9, wherein the manifold comprises a perimeter surface and a face, and wherein the one or more orifices are through the perimeter surface.

12. The apparatus of claim 11, wherein the one or more orifices are through the face of the manifold.

13. The apparatus of claim 1, wherein the device comprises:
an annular shroud and an annular deflector each configured to circumferentially engage a nozzle of the welding gun; and
a gap between the annular shroud and the annular deflector, the annular shroud and the annular deflector configured to direct the flow of air through the gap.

14. A method for shielding welding fumes from a welder, comprising:
providing an apparatus coupled to a welding component, the apparatus comprising one or more orifices;
delivering an airflow through the one or more orifices, the airflow creating an air barrier; and
shielding welding fumes from a welder using the air barrier.

15. The method of claim 14, wherein the air barrier does not disturb a shielding gas emitted from the welding component.

16. The method of claim 14, wherein the welding component comprises a nozzle and a handle, and wherein the apparatus is coupled to the nozzle at a location closer to a tip of the nozzle than the handle.

17. The method of claim 14, wherein the welding component comprises a nozzle and a handle, and wherein the apparatus is coupled to the nozzle proximate the handle.

18. The method of claim 14, wherein the air flow is delivered at a velocity that is greater than 250 cubic feet per hour.

19. The method of claim 14, further comprising diluting the welding fumes with the airflow.

20. An apparatus for shielding welding fumes, comprising:
tubing coupled to a welding helmet, the tubing having one or more orifices configured to direct a flow of air exterior of the welding helmet to divert welding fumes away from a face of a welder.

21. The apparatus of claim 20, wherein the tubing is coupled to a lower perimeter of the welding helmet.
